(19) United States
(12) Patent Application Publication
(10) Pub. No.: US 2010/0100430 A1
(43) Pub. Date: Apr. 22, 2010

(54) RETAIL RATINGS MODULE SYSTEM

(75) Inventors: Margaret M. Koerner, Minden, NV (US); Diane L.K. MacEwan, Palermo, NJ (US); Patricia A. McMahan, Vineland, NJ (US); Charles Leonard Snyder, III, Reno, NV (US); Martin B. Backover, Las Vegas, NV (US)

Correspondence Address: STEPTOE & JOHNSON, LLP, 2121 AVENUE OF THE STARS, SUITE 2800, LOS ANGELES, CA, 90067, US

(73) Assignee: BALLY GAMING, INC., Las Vegas, NV (US)

(21) Appl. No.: 12/254,711

(22) Filed: Oct. 20, 2008

(51) Int. Cl. G06Q 30/00

(52) U.S. Cl. 705/14.12; 705/14.41

(57) ABSTRACT

A retail rating system for use in connection with gambling activities is disclosed. Points or credits are accumulated for commercial activity and made available for gambling activity. A management system and/or player tracking cards are employed to track accumulation of points and commercial activity.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The present disclosure relates to a rating system and more particularly, to a retail rating option to be used in connection with gaming apparatus.

The play of casino games and other games of chance have evolved from a traditional approach where wagering of actual money, such as coins and currency was employed. Coins and currency were traditionally used directly as bets in table games such as poker and blackjack. For other games, the coins and currency are exchanged for chips which have a representative monetary value. Later, bill validators were provided which allowed players to avoid the need to convert their currency to coins before playing a gaming machine.

Outside of the gaming industry, consumers were provided with a large variety of options to effectuate their banking and other monetary transaction needs. For example, the credit card was developed and has become widespread in use. Variations in credit cards have also been developed.

Accordingly, within the gaming industry, efforts have been made to better accommodate clientele. In particular, smart cards have been developed. The smart card may be capable of identifying the rightful cardholder and guarantee the eligibility of that particular visitor to receive the appropriate services and/or products that are stored into the guest card. By implementing the cards as pocket-sized computers, visitors' cards are allowed to operate within a stand alone system, fully integrated system environments, or both as well as proprietary, incompatible system platforms.

Further advancements involved gaming machine systems which are operable with a general purpose charge card. Thus, players are allowed to obtain playing credit with a general purpose charge card which updates an individual's account for wins, losses and draws from games of chance played at one or more machines or at tables at one or more casinos.

Again with an eye on the general consumer market where grocery stores and similar business may reward customers discounts, free products or other awards based upon the customer's level of purchases at the store, gaming operators began to reward players with awards for their level of play of games. In fact, a casino may reward or “comp” a player based on the level of betting or game play by the player. The reward may be free game play, a free night of lodging, food or other awards.

Commonly, whether a player is entitled to an award is based upon the points which are awarded to the player based upon activities in which the player engages. In the case of a grocery store, points may be awarded based upon dollars expended by the customer. In the case of a casino, the points may be awarded based upon dollars wagered. Of course, a wide variety of criteria may be employed for determining how points are assigned and awarded.

Thus, player tracking cards have come into existence. Player tracking programs typically provide rewards, or “comps,” to players in proportion to the player's level of patronage (e.g., to the player's playing frequency and/or total amount of game plays at a given casino). Player tracking rewards may be free meals, free lodging and/or free entertainment. These rewards may help to sustain a game player's interest in additional game play during a visit to a gaming establishment and may entice a player to visit a gaming establishment to partake in various gaming activities.

Prior approaches, however, have not contemplated awards for non-gambling events, such awards being tracked and accumulated along with a player tracking status. There consequently has not been a contemplated approach for rating non-gambling events and tying the same to a player's level of gaming patronage. Accordingly, the present disclosure addresses these and other needs.

### SUMMARY

Briefly, and in general terms, the present disclosure relates to a retail rating system and method. Such a retail rating system is contemplated to be utilized in connection with gambling patronage.

In one approach, points or credit are provided for purchases or commercial activity of patrons at businesses subscribing to or falling within the retail rating system. Such points or credit are contemplated to be added to points or credit achieved through gambling or other activities. Accumulated points or credit can then be employed in further gambling activities or to purchase other services. In one particular approach, both gambling activities and commercial activity falling within the retail rating system are managed by a player tracking system. A player tracking card can be configured to hold such information thereby making the same available for both gambling and other commercial activity.

In one embodiment, an automated retail rating option is contemplated. Thus, participating point of sale vendors (i.e., retail or wholesale shops, hotels etc.) will be networked to the retail rating system which in turn is in operative communication with various casino management systems. In a related embodiment, a manual rating approach can be employed where a consumer is credited for commercial activity and proof of such activity is communicated to a player tracking system.

Participating point of sale vendors and casinos will allow a percentage of points or credit gained through patrons to be reinvested. Various settings for purchase level, activity or patronage category can be provided through player tracking cards or the like, a further dimension of patronage activity can be monitored thereby providing participating entities to better meet patronage needs. All settlements will require revenue setting and a patron account number. A revenue center will attach points/credit to a patron's activity based upon cash or credit card use. Points or credit can be added to patron totals toward a next card level or made available for further gambling or commercial activity.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a flow chart, depicting one embodiment of a system involving a retail rating application;

FIGS. 2A-D are screen shots, depicting various criteria involved in the functionality of a retail rating application;

FIGS. 3A and B are screen shots, depicting an exemplary retail rating files;

FIG. 4 is a screen shot, depicting an exemplary manual retail rating file; and

FIGS. 5A and B are screen shots, depicting an exemplary retail rating patron summary files.

### DETAILED DESCRIPTION

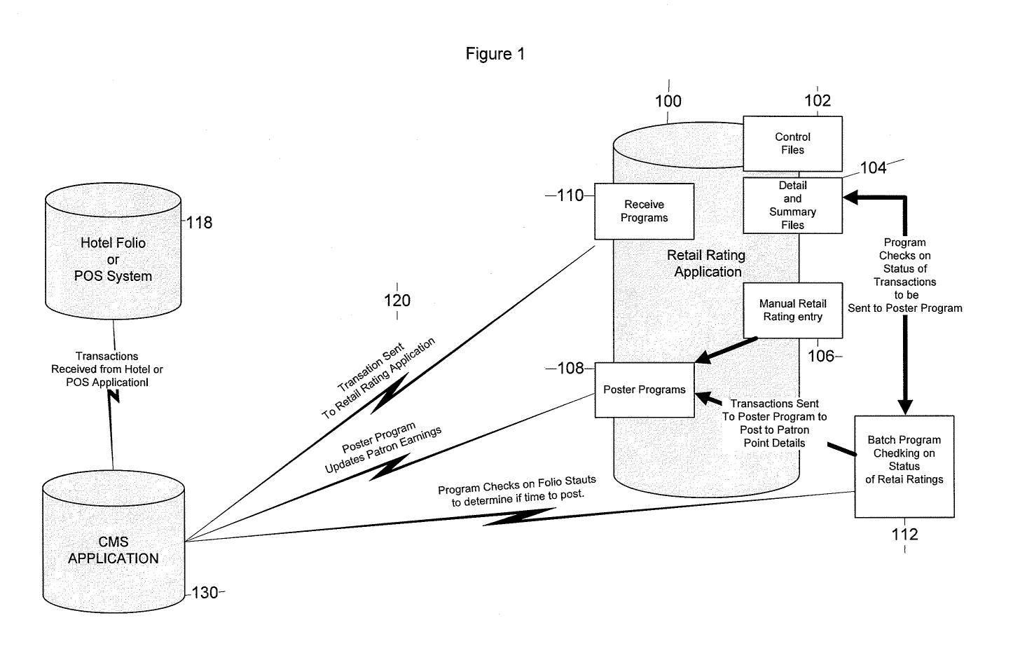

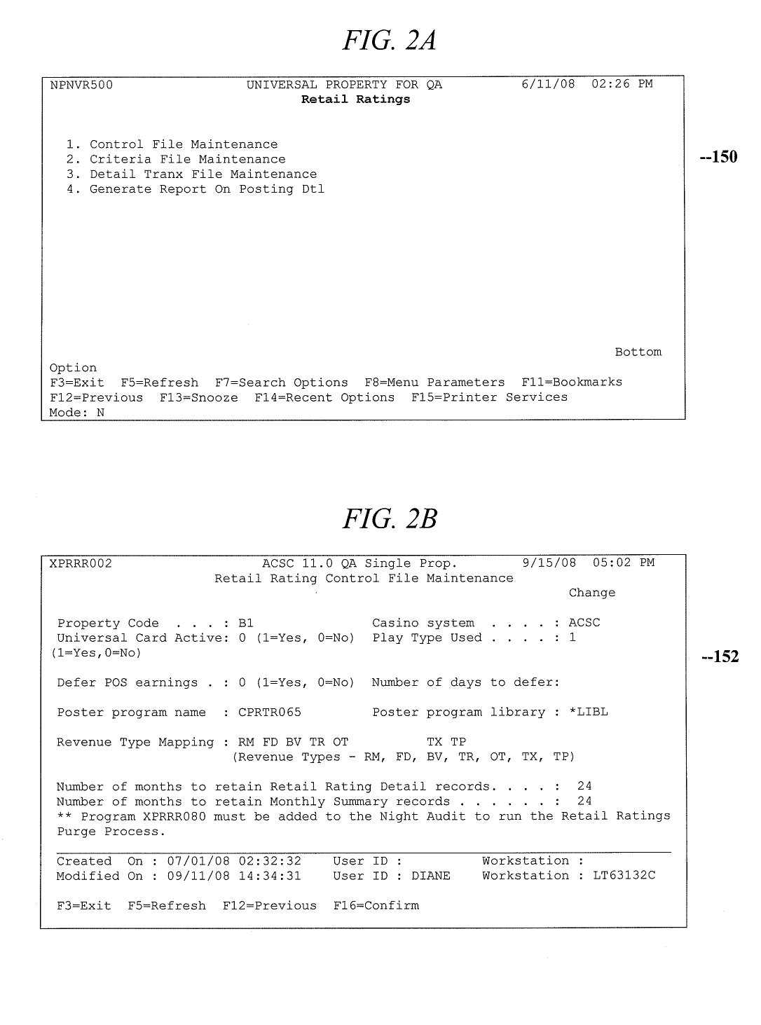

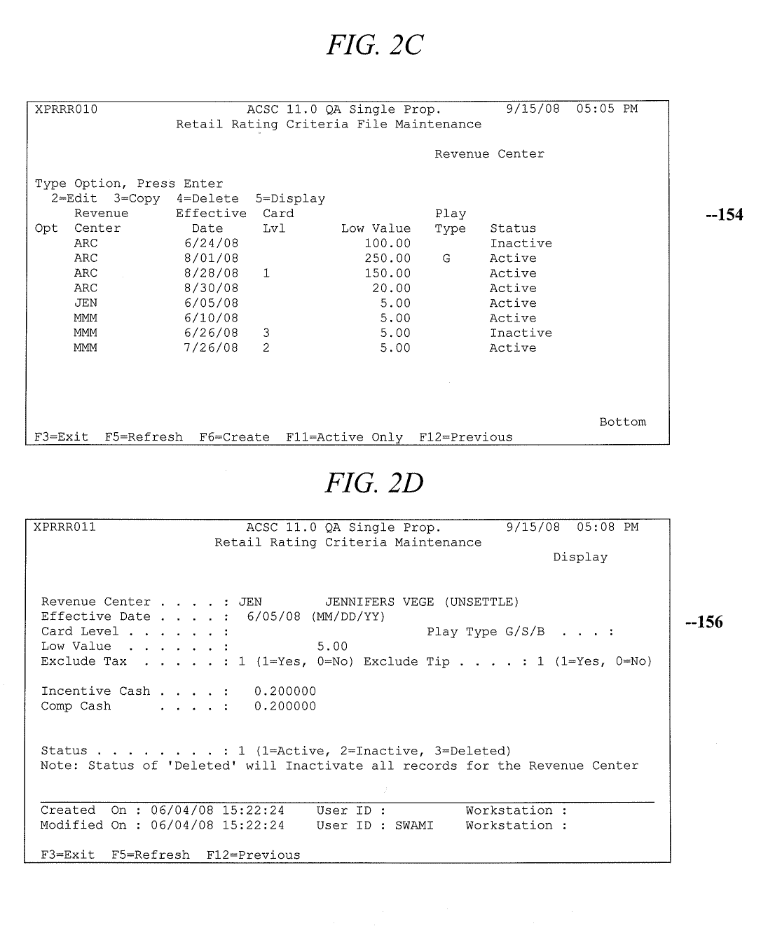

Referring now to the drawings, wherein like reference numerals denote like or corresponding parts throughout the drawings and, more particularly to FIGS. 1 and 2, there are shown various features of a retail ratings application. As is more fully developed below, the retail rating module of the present disclosure includes a system and method providing awards for non-gambling events. Commercial activity associated with the non-gambling events are rated then tracked and accumulated. Points or credit are assigned for the various non-gambling events to be used subsequently for gaming patronage. Thus, an incentive can be created to frequent establishments where points can be generated for gaming activities.

With reference to FIG. 1, there is shown an approach for implementing a retail rating application 100. The retail rating application 100 can be any conventional electronic based, software driven data collection and management system which is capable of being networked with other data systems. In the present application, the retail rating application is intended to interface with non-gaming commercial entities such as hotel or point of sale (POS) retailers or wholesalers.

In one approach, the retail rating application includes one or more of control files 102, detail and summary files 104 and a manual retail rating entry system 106. The retail rating application is also operatively associated with one or more poster programs 108 as well as one or more receiving programs 110. The detail file 104 communicates with a batch program 112 configured to check status of retail ratings and status of transactions to be sent to the poster program 108.

Additionally, both the manual retail rating entry system 106 and the batch program 112 communicate directly or indirectly with the poster program 108. With specific regard to the batch program 112, transactions are sent to the poster program 108 to post information to patron point details. Point of Sale (POS) transactions can be posted directly or deferred.

Pathways are contemplated which function to provide communication routes between the various non-gaming commercial entities and the retail rating application 100. Conventional approaches can be employed to operatively connect the retail rating application 100 and participating non-gaming commercial entities.

Accordingly, communication with the particular non-gaming entities to establish retail ratings for various commercial activities such as those from hotel or other point of sale activities is contemplated, the same being monitored in and communicated from a hotel folio or POS system 118. Thus, a retail rating can be developed for services being rendered or products sold to a patron. The non-gaming entity will submit an application to join the retail rating application system 100 and then be provided a patron number. Based upon a number of agreed to guidelines, points or credit for commercial activity at the non-gaming entity will be assigned to thereby generate retail ratings for each qualifying non-gaming commercial event. It is also contemplated that points could be awarded for qualifying non-commercial events.

The retail rating application 100 can be configured to communicate through conventional means with the various casino management systems (CMS) 110 utilized in the gaming industry, the CMS being in communication with the hotel folio or POS system 118. The retail rating module 100 can also be adapted to cooperate with casino management systems now contemplated or developed in the future. In this regard, a communication pathway 120 can be established between the retail rating application 100 and a CMS application 130. Details concerning the manner in which points or credit are awarded, as well as controls for ratings and point tallies are stored and governed by the retail rating module 100. The CMS further interacts with the retail rating module 100 to permit the use of accumulated points for gaming activities. Moreover, the CMS 110 will store information concerning commercial as well as gaming activity of a patron, such information being then available for marketing purposes.

In one specific approach, the communication pathway can involve transactions sent from a CMS application 130 to the receive programs 110 of the retail rating application 100. Also, a communication route between the poster program 108 and the CMS application 130 is provided so that patron earnings can be updated. Further, communication between the batch program 112 of the retail rating application 100 and the CMS application 130 effectuates checks on folio status to determine if it is time to post information.

Referring now to FIGS. 2A-D, various features of one example of a retail ratings application are presented. An interactive screen including a menu 150 (FIG. 2A) providing an access to control file maintenance, criteria file maintenance, detail file maintenance and posting reporting functions can be made available. Property controls (See FIG. 2B) can be expressed and tracked utilizing a retail rating control maintenance file 152 which can be set up to store information concerning commercial transactions for a particular property. It is also contemplated that the retail rating application include a revenue center control system 154 which tracks commercial activity by revenue center and play type (See FIG. 2C). Several options can be made available through the revenue center control such as an ability to display 156 specific retail rating criteria maintenance information for a particular property, such as that depicted in FIG. 2D.

In one typical scenario, a patron settles a bill such as a hotel charge or a cost or fee associated with commercial activity at a retail or wholesale store by paying cash or using a credit or debit card. This transaction is then posted as a data point within a guest pay folio. Next, a query is generated to determine if the transaction has a casino patron number associated therewith. If there is no patron number associated with the particular commercial activity, the transaction is ended. If, however, there is a patron number assigned to the commercial transaction category, the information concerning the commercial activity is transmitted to the retail rating application 100.

The retail rating application 100 analyzes whether the commercial activity meets pre-determined criteria for retail rating. If either the commercial activity or the non-gaming entity does not meet relevant pre-determined criteria, the analysis process is completed and the subject transaction is not posted or otherwise recorded on the retail rating application 100 and no points or credits are calculated. It is to be recognized, however, in alternative approaches, the commercial activity can be recorded by the retail rating application 100 whether or not points or credit are awarded to the patron.

Where the commercial activity does indeed meet pre-established criteria for retail rating, points can be calculated based on soft settings. Such soft settings can be modified upon agreement between participating commercial entities and gaming institutions. The settings are also contemplated to vary based upon patron commercial or gaming activity. Contemporaneously, a record is created in the retail rating application 100 to thereby develop a database of commercial activity which can be utilized in marketing efforts.

The transaction data including an analysis of the commercial activity is sent to the relevant CMS 130. The CMS can be configured to post the data points associated with the commercial activity, including details concerning the specifics of the commercial activity. Additionally, points awarded for the transaction are also posted and associated with the particular patron.

Thereafter, the CMS 130 updates points earned by the subject patron. The CMS can also be configured to run a check to determine whether a player's tracking card level or other patron associated characterized should be upgraded. Thus, the patron can receive points for further gaming or non-gaming activity and/or benefits associated with higher player tracking levels.

In the management of a system including a retail rating application, numerous factors can be considered and tracked. While the following is not meant to be an exhaustive discussion of factors which can be considered, it is noted that the retail rating application can include a retail rating maintenance file. The retail rating maintenance file 152 can track information for participating revenue centers as well as dates concerning commencement of participation to termination of participation. In this way, participating entities can be contacted in advance of termination of participation. Where relevant, a play type and/or commercial activity is tracked as are any limitations or advantages associates with a player card level used in the relevant transaction category. Various sub-categories can also be monitored such as award percentages for bonus points or “comp” points. Also, incentive points and discretionary points can be awarded for certain activities and have associated therewith their own specific percentages. Options can further be established regarding excluding taxes or tips from point calculations. Moreover, transition dates and information and status can also be tracked so that for example, awards can be made to expire or simply tracked for marketing purposes.

A detail rating file can also be gathered and maintained by a retail rating module. Such a file can be linked to a patron number and can further be associated with a revenue center. Whether informational tickets are generated either by the commercial or gaming entity, a ticket number record can also be tracked. Transaction, reservation and portfolio data can be further gathered and monitored in the detail rating file to provide specifics regarding patron activity as is sales, tax and tip information. Again, as for the maintenance file, bonus, “comp”, incentive and discretionary points and information are tracked as is relevant status information.

The “other trip history file” is associated with a patron number. In addition to tracking details such as dates, sales amount and commercial activity category (room, food, transportation etc.), bonus, “comp” and incentive points, discretionary worth can be monitored. Furthermore, player tracking card points earned can be gathered and tracked under this file category.

For convenience, the retail rating module can be configured to further track yearly retail worth and LTD retail worth. These data files can track the foregoing mentioned commercial activity categories for periods of interest such as for a particular year or provide for example, running totals.

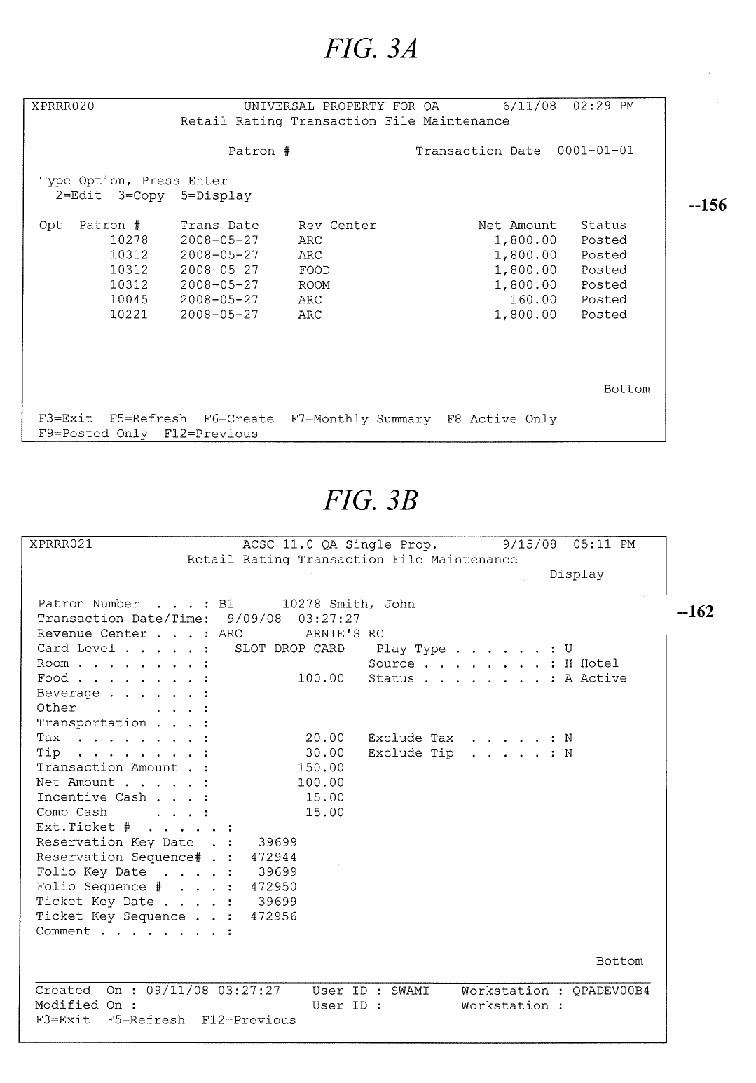

As shown in FIGS. 3A and B, one particular approach to accumulating detailed information is presented. Here, the retail rating application can include software which generates an interactive screens 160, 162 for entering and monitoring details concerning commercial activity for a particular entity. Such data can be automatically transmitted from a non-gaming entity as a result of commercial activity (such as when the transaction involves use of a player tracking card) or can be provided directly from a ticket receipt reader. Thus, a retail rating file can identify a particular revenue center and link that with a specific patron so that a determination can be made concerning awarding credit or points to a patron to be used for gaming or other purposes. The patron's commercial activity would be entered and stored so that dollar amounts, client activity worth and where relevant, a ticket number are memorialized. The software controlling the data entry screen would be further equipped to conduct searches as well as other well known database functions.

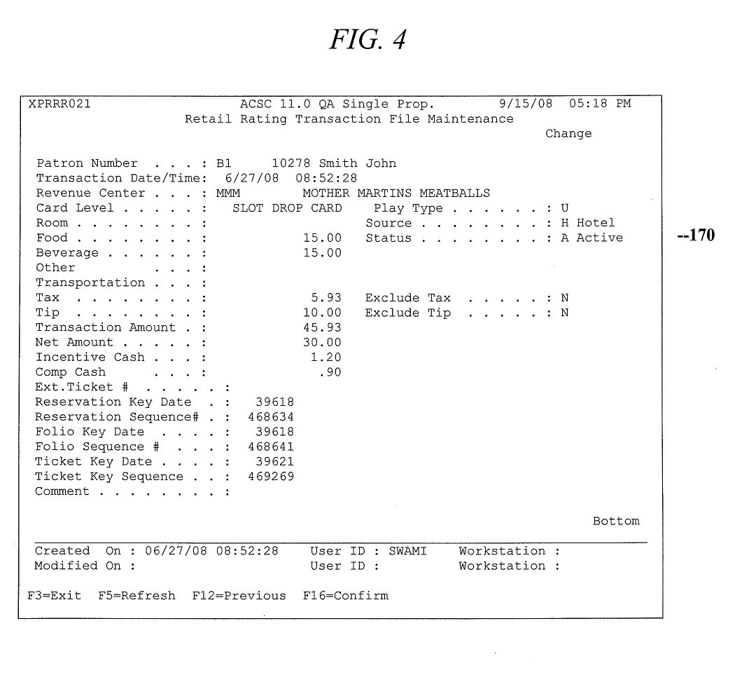

As mentioned, the retail rating application can involve or accommodate manual approaches to tracking non-gaming commercial activity (See FIG. 4). For example, a system can be configured to provide or accommodate a manual retail rating screen 170 where manual retail rating information is gathered. Details concerning a particular commercial transaction can be manually entered into a screen bearing a patron name. Thus, the patron's number, the relevant revenue center, associated ticket number, tax, date and time information can be tracked and ultimately used to determine whether and to what extend points are awarded to a patron. Again, relevant software can be configured to provide searching and other functions making it convenient to manage both the subject file as well as various other saved files.

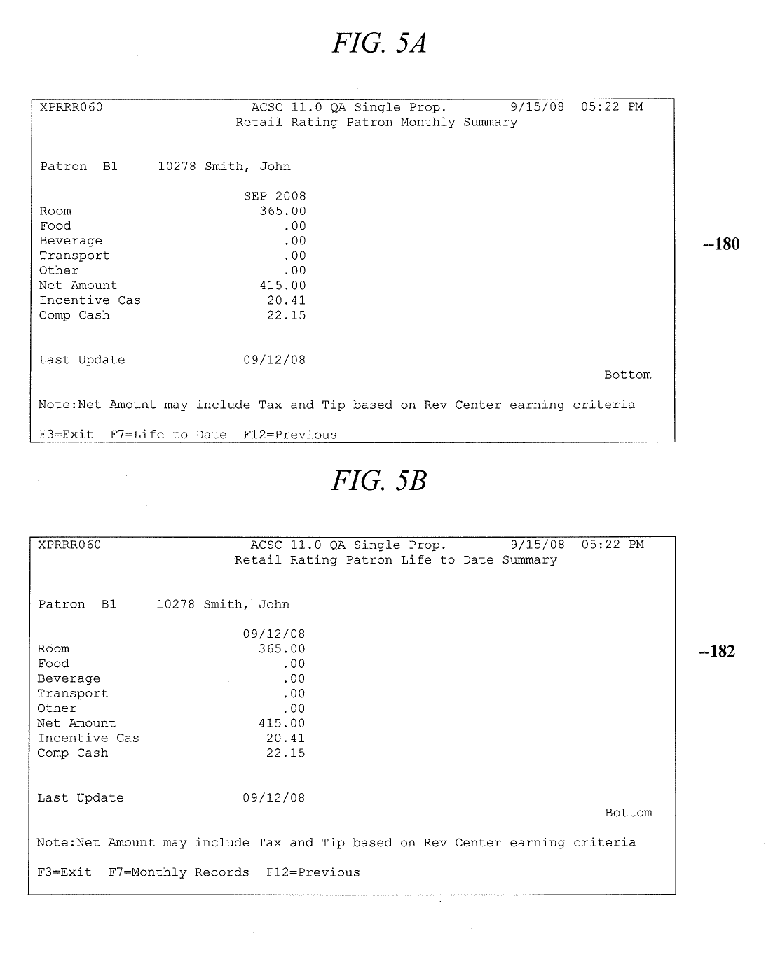

As shown in FIGS. 5A and B, software can be developed to provide interactive screens 180, 182 to track and summarize retail history. Both life to date 180 and monthly information 182 can be provided. Moreover, total “comp” points, bonus points, incentive points and discretionary and player tracking card points can be stored in a file associated with a particular patron for a particular casino. Such information along with other data stored can conveniently be used to address the commercial patterns of a patron and thus potentially provide an enhanced leisure experience.

Accordingly, the present disclosure provides a system including and method involving a retail rating application to thereby assign awards for non-gambling events. Such awards are tracked and made available for use in gaming activity. The amount of an award can be set for various levels of activity as well as based upon a historical view of activity both in gaming and non-gaming events.

One of ordinary skill in the art will appreciate that not all embodiments are required to have all these components and may have other components in addition to, or in lieu of, those components mentioned here. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A retail rating system, including:
at least one participating gambling entity;
at least one participating point of sale entity;
a management system providing communication interface between participating entities; and
a retail rating application, the retail rating application assigning points to commercial activity of a patron at a point of sale entity;
wherein the points assigned by retail rating application are accumulated and made available for use at the at least one participating gambling entity.

2. The system of claim 1, wherein the points assigned by the retail rating module are made available for use at the at least one participating point of sale entity.

3. The system of claim 1, wherein there are a plurality of participating gambling entities.

4. The system of claim 4, wherein there are a plurality of participating point of sale entities.

5. The system of claim 4, wherein one of the plurality of participating point of sale entities is a hotel.

6. The system of claim 4, wherein the retail rating includes multiple settings.

7. The system of claim 6, wherein the multiple settings are dependent upon a level of commercial activity.

8. The system of claim 7, wherein the multiple settings are dependent upon a player type.

9. The system of claim 8, wherein the player type is based upon gambling activity.

10. The system of claim 9, wherein the multiple settings are dependent upon a tracking card level.

11. The system of claim 10, wherein the tracking card level can be increased in response to points accumulated through commercial activity.

12. The system of claim 11, wherein points are not accumulated for taxes paid in connection with commercial activity.

13. The system of claim 11, wherein points are not accumulated for tips paid for services rendered.

14. The system of claim 11, wherein a percentage of commercial activity at one of the plurality of point of sale entities is assigned points for use at a participating gambling entity.

15. The system of claim 14, wherein the management system is a casino management system.

16. The system of claim 15, wherein the retail rating system includes a manual rating system.

17. The system of claim 16, wherein vouchers are generated by the manual rating system.

18. The system of claim 15, wherein discretionary points are generated through commercial activity.

19. The system of claim 15, wherein incentive points are generated through commercial activity.

20. The system of claim 1, wherein retail activity is tracked by the retail rating system.
